(19) United States
(12) Patent Application Publication
(10) Pub. No.: US 2024/0127031 A1
(43) Pub. Date: Apr. 18, 2024

(54) GRAPH NEURAL NETWORK MODEL FOR NEURAL NETWORK SCHEDULING DECISIONS

(71) Applicant: Intel Corporation, Santa Clara, CA (US)

(72) Inventors: Hamza Yous, Dublin (IE); Ian Hunter, Carnaross (IE); Alessandro Palla, Pisa (IT)

(73) Assignee: Intel Corporation, Santa Clara, CA (US)

(21) Appl. No.: 18/394,307

(22) Filed: Dec. 22, 2023

(51) Int. Cl. G06N 3/042; G06N 3/08

(52) U.S. Cl. CPC G06N 3/042; G06N 3/08

(57) ABSTRACT

A graph neural network (GNN) model is used in a scheduling process for compiling a deep neural network (DNN). The DNN, and parameter options for scheduling the DNN, are represented as a graph, and the GNN predicts a set of parameters that is expected to have a low cost. Using the GNN-based model, a compiler can produce a schedule for compiling the DNN in a relatively short and predictable amount of time, even for DNNs with many layers and/or many parameter options. For example, the GNN-based model reduces the overhead of exploring every parameter combination and does not exclude combinations from consideration like prior heuristic-based approaches.

### TECHNICAL FIELD

This disclosure relates generally to neural networks, and more specifically, to scheduling graphs for compiling deep neural networks (DNNs).

### BACKGROUND

DNNs are used extensively for a variety of artificial intelligence applications ranging from computer vision to speech recognition and natural language processing due to their ability to achieve high accuracy. Neural networks typically include multiple layers, and work in each layer is distributed among different processing units. Work performed by a processing unit may be, for example, a convolution or another tensor computation. Individual processing units communicate with other processing units, e.g., in different layers of the neural network. Neural network compilers can make various decisions about how to execute a piece of work on a target hardware environment.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates a neural network compiler environment, in accordance with various embodiments.

FIG. 3 illustrates an example graph representing a search space for neural network scheduler, in accordance with various embodiments.

FIGS. 4A and 4B illustrate two example configurations selected by a neural network scheduler, in accordance with various embodiments.

FIG. 5 is a block diagram of a scheduler for a neural network compiler, in accordance with various embodiments.

FIG. 6 illustrates an example supervised learning environment for a neural network scheduling model, in accordance with various embodiments.

FIG. 7 illustrates an example flowchart for generating data for training the neural network in the environment of FIG. 6, in accordance with various embodiments.

FIG. 8 illustrates an example reinforcement learning environment for a neural network scheduling model, in accordance with various embodiments.

FIG. 9 is a flowchart showing a method of generating a schedule for a neural network compiler, in accordance with various embodiments.

FIG. 10 is a block diagram of an example computing device, in accordance with various embodiments.

### DETAILED DESCRIPTION

### Overview

Deep learning is a subset of machine learning that is based on artificial neural networks with representation learning. A neural network is considered “deep” if it includes multiple layers arranged in a network, e.g., at least one hidden layer between an input layer and an output layer. DNNs are widely used in the domains of computer vision, speech recognition, image processing, and video processing. Innovations in the field of machine learning, and new ways of applying DNNs, are making DNNs larger and “deeper,” with an exploding number of neurons and corresponding computations. For example, large language models (LLMs) can be implemented as DNNs that include billions of neurons.

A neural network compiler is a tool for translating a neural network model, which may be expressed in a deep learning framework like TensorFlow, into a format for execution on a specific hardware platform. The neural network compiler converts the high-level model definition into low-level hardware instructions, enabling the deployment of a neural network model on a specific device, such as one or more central processing units (CPUs), graphical processing units (GPUs), or specialized neural network hardware, such as neural processing units (NPUs).

A neural network compiler can make various decisions about how to execute a piece of work on a target hardware. These decisions can include splitting the task into subtasks over tensor axes, datatype castings, or enabling or disabling certain features. Each option may be referred to as a parameter. In prior methods, each combination of parameters is assigned a different cost value that can be calculated by a mathematical or algorithmic model of how the task would perform on the target hardware. However, it can take the compiler a lot of time to generate the different schedules based on the different combinations of parameters, particularly for large DNNs (e.g., DNNs with many layers) and/or many options available for each layer. Typically, a brute force method is used to calculate costs for all the schedule options, and the schedule with the lowest cost is selected. Due to the combinatorial nature of neural networks with multiple layers, the scheduler may calculate costs for hundreds of thousands of different configurations, which can be quite costly and time-consuming. If the scheduling options are very numerous, heuristics can be used to reduce the search space; however, heuristics can mistakenly remove high-performance options from consideration.

More generally, in the context of a DNN compiler, scheduling can be considered a graph search problem. The DNN is represented as a graph, where the nodes represent the layers' attributes, such as input/output tensor sizes, and the edges represent the dependencies between the layer operations. The dependencies exist because the execution of each layer involves data received from the previous layer, and a given layer makes the output data available for the next layer or layers. Representing the DNN as a graph allows a global optimization approach to the scheduling problem.

As described herein, a graph neural network (GNN) model can be used in the scheduling process, to generate a result to the global optimization problem for the graph. The GNN can predict a set of parameters for a given DNN that is expected to have a low cost. Using the GNN-based model, a compiler can produce a schedule for compiling the DNN without the runtime slowdown of continuous cost querying. The GNN-based model reduces the overhead of exploring every parameter combination and does not exclude combinations from consideration like the heuristic-based approach. Thus, the scheduler described herein can enable a faster compiler execution time while allowing a greater number of scheduling options to be considered than in prior approaches. Furthermore, as more parameters for compiling a neural network are offered, the GNN-based approach can handle the ballooning number of scheduling options.

In some cases, the GNN-based scheduler can enable just-in-time (JIT) compiling, where code is compiled right before it is executed, rather than being compiled ahead of time (AOT) and stored as machine code before the program is run. In the context of DNNs, JIT compilation can be useful for optimizing the execution of models on specific hardware. For example, a neural network can be fine-tuned for particular hardware, and quickly adapted to different or additional hardware (e.g., hardware with more or fewer compute units, or with different clock speeds).

As described herein, a neural network compiler may generate or receive a graph describing a target neural network (e.g., a DNN) to be compiled. The graph may include nodes and edges, where the nodes arranged in multiple layers. One of the nodes in a given layer represents at least one parameter of the given layer, and one of the edges represents a dependency between a first layer and a second layer. The neural network compiler provides a representation of the graph to a trained model, e.g., a trained GNN model, which processes the representation to produce an output embedding that represents a scheduling configuration of the neural network. The scheduling configuration provides a scheduling strategy for each layer of the neural network to be compiled. The output embedding is received by the neural network compiler (e.g., by a decoder). The neural network compiler (e.g., the decoder) outputs a schedule for compiling the neural network based on the output embedding. The neural network compiler (e.g., a hardware lowering component) may compile the target neural network according to the schedule.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN compiler that comprises a list of elements is not necessarily limited to only those elements but may include other elements not expressly listed or inherent to such method, process, device, or DNN compilers. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

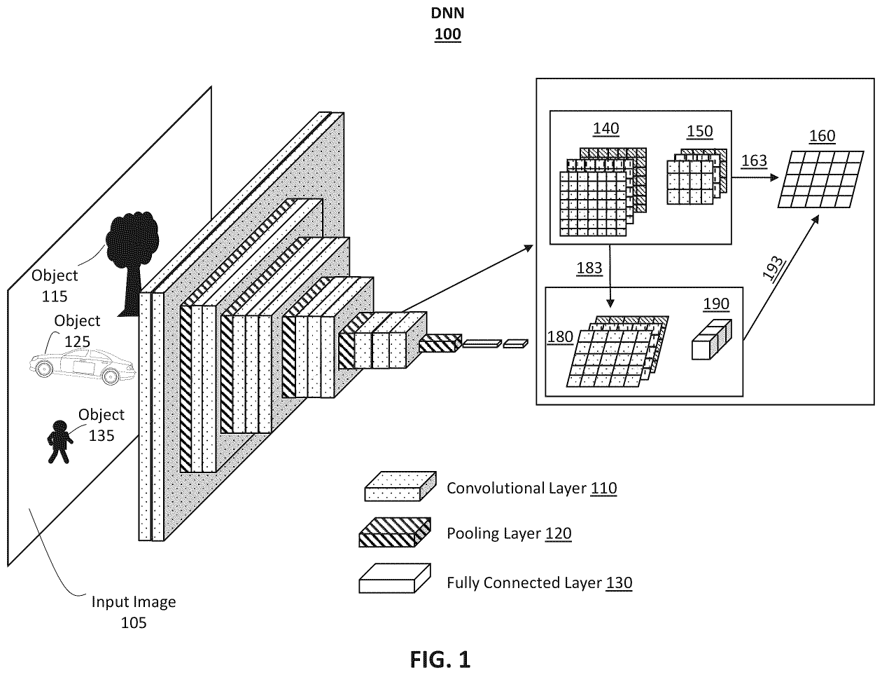

FIG. 1 illustrates an example DNN 100, in accordance with various embodiments. For purpose of illustration, the DNN 100 in FIG. 1 is a convolutional neural network (CNN). In other embodiments, the DNN 100 may be other types of DNNs, such as an LLM. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes three input channels, each of which is represented by a 7×7 two-dimensional (2D) array. The 7×7 2D array includes 7 input elements (also referred to as input points) in each row and 7 input elements in each column. The filter 150 is represented by a 3×3×3 3D matrix. The filter 150 includes three kernels, each of which may correspond to a different input channel of the IFM 140. A kernel a 2D array of weights, where the weights are arranged in columns and rows. A kernel can be smaller than the IFM. In the embodiments of FIG. 1, each kernel is represented by a 3×3 2D array. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as OFM 160). The OFM 160 is represented by a 5×5 2D array. The 5×5 2D array includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D array of output elements. As such, the 2D output array (i.e., the OFM 160) from the standard convolution 163 is referred to an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes three output channels, each of which is represented by a 5×5 2D array. The 5×5 2D array includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiments of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example Neural Network Compiler Environment

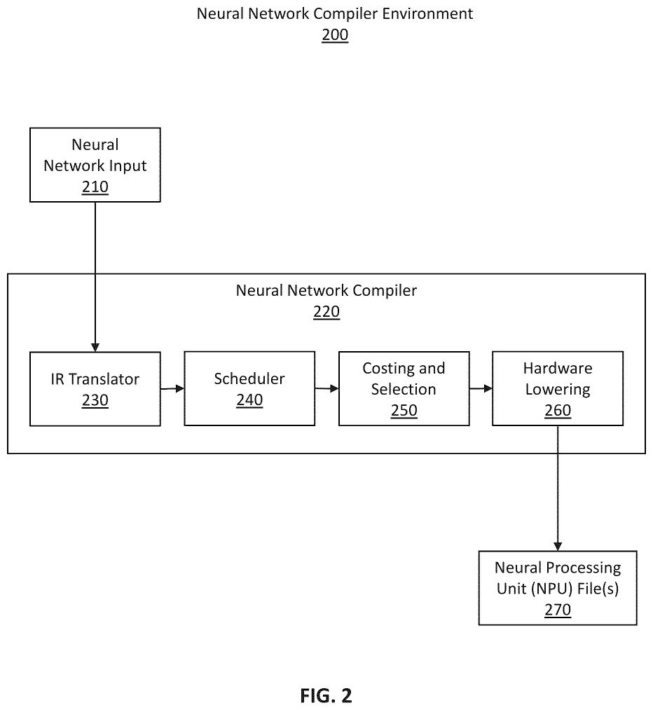

FIG. 2 illustrates a neural network compiler environment 200, in accordance with various embodiments. To execute a neural network, such as the DNN 100, on a target hardware, the neural network input 210 is compiled by a neural network compiler 220, which generates executable files for the neural network, e.g., NPU files 270 that can run on NPUs. In this example, the neural network compiler 220 includes modules or sub-processes for an IR translator 230, a scheduler 240, costing and selection 250, and hardware lowering 260. Each of the modules 230-260 may be at least partially implemented in software and/or at least partially implemented in hardware. In other embodiments, alternative configurations, different or additional components may be included in the neural network compiler 220. Further, functionality attributed to a component of the neural network compiler 220 may be accomplished by a different component included in the neural network compiler 220 or by a different system.

The neural network input 210 describes a neural network for compiling. The neural network input 210 may include source code describing a neural network model. Source code is a set of computer program instructions in a human-readable form. The source code is written in a high-level programming language, such as C, C++, Java, Python, and so on. The source code cannot be executed by processing devices (e.g., NPUs) directly and needs to be converted (here, by the neural network compiler 220) to machine code that is executable by the processing device.

In some embodiments, at least a portion of the neural network input 210 includes source code from another system or device, e.g., from a library of a deep learning frameworks. The neural network input 210 may further include one or more parameters for implementing the neural network. The parameters may be provided along with the source code, e.g., specified by a file from the library. Alternatively, one or more parameters may be directly provided by a user, e.g., in a menu or other interface for user input. Parameters may include options for splitting a tensor, data types, data precision, etc. Different parameters may be specified for different layers of the neural network. In some cases, a user or input file may indicate a subset of available parameters to be considered for a given neural network or portion (e.g., a layer) of a neural network.

In some cases, the parameter options may be tied to the hardware specifications. The neural network input 210 may include hardware specifications, e.g., specifications of NPUs or other processing units for executing the compiled neural network. The hardware specifications may include processing capabilities (e.g., operations supported by the hardware), allocated memory, number of compute units, clock speeds, etc.

The IR translator 230 receives the neural network input 210 and converts the neural network input 210 (and, in particular, the source code) to an intermediate representation (IR). An IR is a data structure that represents the source code. The IR represents different sets of parameter options indicated in the neural network input 210. As described with respect to FIG. 1, a DNN may be arranged in a group of layers, e.g., convolutional layers 110 and pooling layers 120. In the IR, at least a portion of the DNN layers (e.g., the convolutional layers 110) may be represented as a layer of the IR. The IR may be arranged as a graph, where nodes in the graph represent the layers attributes, such as input/output tensor sizes, and the edges represent the dependencies between the layer operations.

More particularly, the nodes may describe the tensor operation to be executed, e.g., convolution, pooling operation, elementwise operation, reducing tensor, loading tensor, other tensor operations, or some combination thereof. The nodes may further include tensor references, such as tensor rank (i.e., the number of dimension(s) of the tensor, e.g., 1, 2, 3, etc.), tensor shape (i.e., the number of elements in each dimension of the tensor), tensor length (the total number of elements in the tensor), other tensor references, or some combination thereof.

The IR generated by the IR translator 230 may be a graph that represents a search space for the scheduler 240. In principle, the IR translator 230 converts a graph representing the target neural network (here, the neural network represented by the neural network input 210) to a parametrization graph, where the nodes in the parameterization graph represent different configuration options, and the edges represent the cost associated to execute each NN layer using a given configuration and execute the next layer using another configuration.

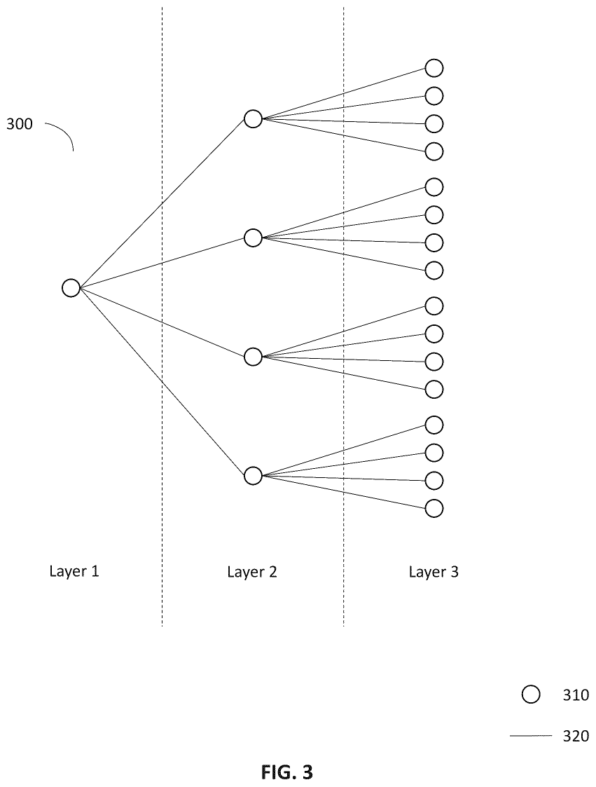

FIG. 3 illustrates an example graph representing a search space for neural network scheduler, in accordance with various embodiments. FIG. 3 includes three layers, labelled layer 1, layer 2, and layer 3. Layer 1 includes one node 310, which may represent an input layer of the neural network. In other examples, layer 1 may include multiple nodes. Layer 2 includes four nodes 310, each of which is connected to the node in layer 1 by a respective edge 320. Layer 2 may represent different options for a second layer of a DNN, e.g., for the first convolutional layer 110 following the input layer of the DNN 100. Each node in layer 2 may represent a different combination of parameters. For example, one node in layer 2 may represent an integer datatype and a depthwise tensor segmentation; the next node in layer 2 may represent a floating point datatype and a depthwise tensor segmentation; the next node in layer 2 may represent an integer datatype and a lengthwise tensor segmentation; and the last node in layer 2 may represent a floating point datatype and a lengthwise tensor segmentation.

Layer 3 may represent different options for a third layer of a DNN, e.g., for the second convolutional layer 110 of the DNN 100. Each of the nodes in layer 3 depends on the node selected in layer 2. Each node in layer 3 may represent a combination of parameters. For example, each of the nodes in layer 3 connected to the uppermost node in layer 2 may represent one of the same combinations of parameters of layer 2. Likewise, each of the nodes in layer 3 connected to the second uppermost node in layer 2 may represent one of the same combinations of parameters of layer 2. In other examples, different parameter options may be available for different layers.

Each path through the graph 300 represents a different combination of parameters at each layer of the graph. The goal of the scheduler 240 and, if present in the neural network compiler 220, the costing and selection module 250 is to select one of the combination of parameters for scheduling, which is represented by one of the paths through the graph 300.

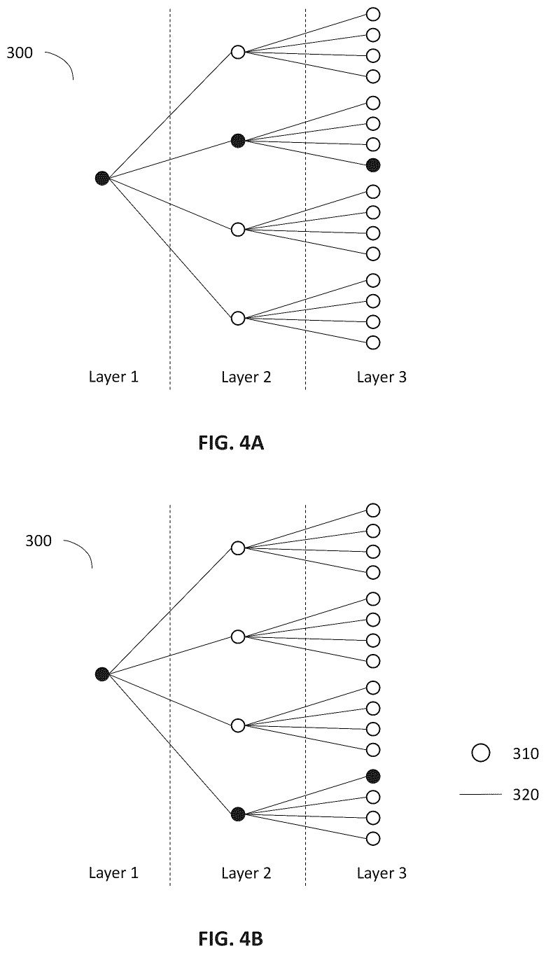

FIGS. 4A and 4B illustrate two example configurations of the neural network which may be selected by a neural network scheduler, in accordance with various embodiments. In FIGS. 4A and 4B, the filled-in nodes represent the selected nodes in each layer. In FIG. 4A and FIG. 4B, the node in layer 1 is selected by default. In FIG. 4A, the second node from the top in layer 2 is selected. In layer 3, the bottommost node in the node group connected to the second node in layer 2 is selected. This may represent, for example, that at layer 2, a floating point datatype and a depthwise tensor segmentation are selected, and that at layer 3, a floating point datatype and a lengthwise tensor segmentation are selected. In FIG. 4B, the bottommost node in layer 2 is selected. In layer 3, the top node the node group connected to the bottommost node in layer 2 is selected. This may represent, for example, that at layer 2, a floating point datatype and a lengthwise tensor segmentation are selected, and that at layer 3, an integer datatype and a depthwise tensor segmentation are selected.

FIGS. 4A and 4B illustrate two example paths through the graph 300. In the graph 300, there are sixteen possible paths through the graph 300, each path terminating in a different node in layer 3. In a traditional approach, the total cost of each path through the graph is computed, and the optimal path (e.g., the path with the lowest cost) is selected for compiling. However, as noted above, this can lead to a very large search space. The graph 300 represents a relatively shallow neural network, with only three layers, and a small number of options for each layer. As the number of types of parameters, number of options for a given parameter, and/or number of layers increases, the number of paths through the graph explodes. An optimizer that needs to evaluate the cost of each individual path to find the best solution leads to a long compilation time and, if heuristics are used to trim the search space, often leads to a suboptimal solution.

Turning back to FIG. 2, the scheduler 240 receives an IR (e.g., the graph 300) from the IR translator 230 and uses a machine-learned model to identify one of the paths, or a subset of paths, through the graph 300, where the identified path or subset of paths is expected to have a low cost. For example, the scheduler 240 inputs a representation of a parameterization graph of a neural network to be compiled to a GNN model, and the GNN model outputs an embedding representing a scheduling configuration of the neural network. The scheduling configuration provides a scheduling strategy (e.g., one or more parameters) for each layer of the neural network to be compiled. The scheduler 240 may decode the embedding to output a schedule for compiling the neural network. As described above, using the GNN-based scheduler 240 reduces the optimization complexity and results in a neural network compiler 220 with a lower compilation time compared to prior approaches.

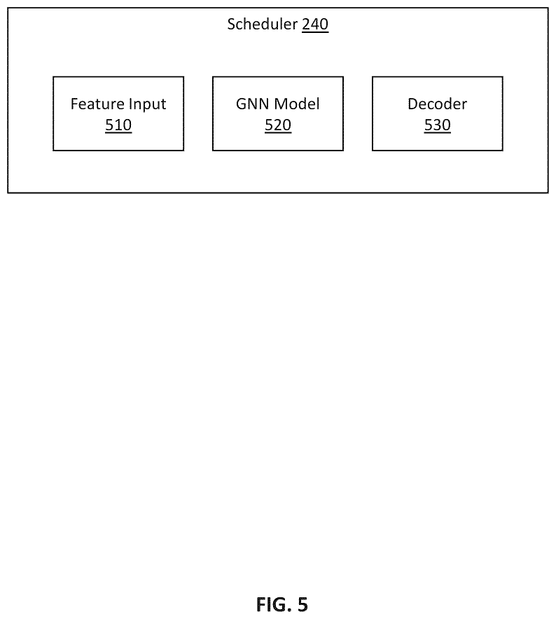

FIG. 5 is a block diagram showing the scheduler 240 in greater detail. The scheduler 240 includes a feature input module 510, a GNN model 520, and a decoder 530. The feature input module 510 may receive an IR from the IR translator 230 and format the IR (e.g., the graph 300) into a suitable input for the GNN model 520. For example, the feature input module 510 may generate a vector or embedding based on the IR. In some embodiments, the feature input module 510 may generate an embedding for each node of the IR, e.g., each node of the graph 300, and these embeddings may be input to the GNN model 520. The embedding for a given node may be based on the parameters for the node and, in some cases, one or more nodes connected to the node (e.g., a node connected to the node in another layer). The embeddings may be assembled into a matrix that is input into the GNN model 520.

The GNN model 520 processes the received input to identify one or more scheduling configurations represented by the parameterized graph, e.g., the graph 300. The GNN model 520 is trained using machine learning to identify a route through the graph that is expected to have an optimal cost according to a given cost function. The GNN model 520 may be trained for a particular cost function. The cost function may be based on, for example, an amount of power to run the DNN, a number of cycles for the DNN to generate a result, a length of time for the DNN to generate a result, other performance factors, or a combination of factors. The cost may be specific to a particular target hardware for the DNN.

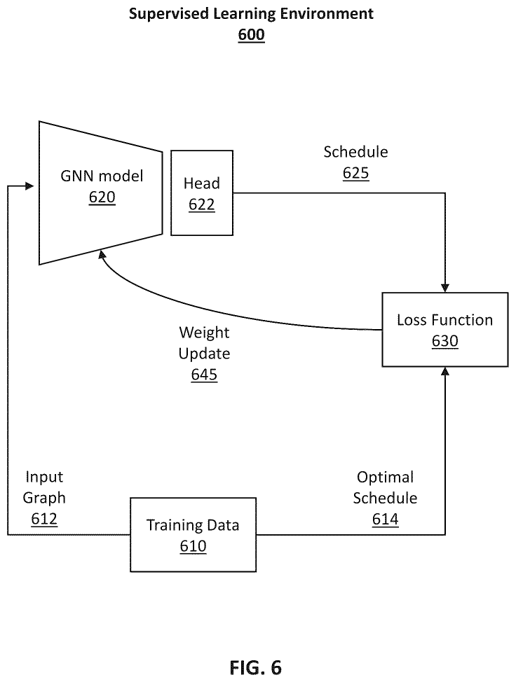

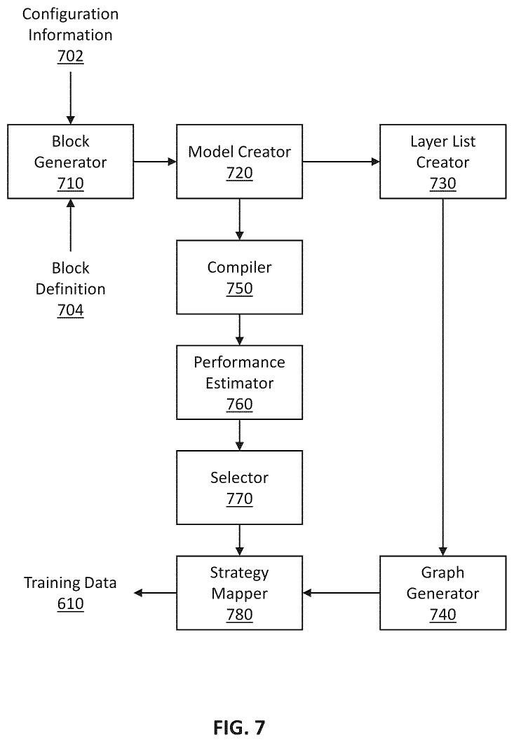

In general, the GNN model 520 is a multi-layer model that encodes structural information about the parameterization graph and processes the structural information to determine an optimal route through the graph, where the optimal route represents a compiling schedule. The GNN model 520 may involve a message-passing process between the nodes, so that each node aggregates its embedding with embeddings received from the adjacent nodes in the graph. The GNN model 520 may be trained using, for example, reinforcement learning or supervised learning. Two example training algorithms are described with respect to FIGS. 6 and 7.

In some embodiments, the neural network compiler 220 includes multiple GNN models 520, each of which may be trained based on different cost functions. When a user uses the neural network compiler 220 to compile a DNN, the user can select a particular feature or set of features to optimize, and the neural network compiler 220 may choose the GNN model that is trained for the suitable cost function. In some embodiments, the neural network compiler 220 may be capable of training a new GNN model. For example, a user may input a particular cost function, or features relating to a cost function, and the neural network compiler 220 may train a GNN model based on the requested cost function. The neural network compiler 220 may then use the newly trained GNN model in the scheduler 240.

The scheduler 240 further includes a decoder 530. The decoder 530 may interpret the output of the GNN model 520, e.g., to provide a schedule based on the output of the GNN model 520. For example, the decoder 530 may be a classification head that associates a label to each node of the graph. The schedule for compiling the neural network may be represented by the labels.

Returning to FIG. 2, in some embodiments, the neural network compiler 220 includes a costing and selection module 250. As noted above, in some embodiments, the scheduler 240 outputs a set of scheduling configurations that are expected to have relatively low costs. For example, the GNN model 520 may output a set of embeddings (e.g., 10 embeddings or 50 embeddings) representing different scheduling configurations. In such embodiments, the costing and selection module 250 may compare the different scheduling configurations represented by the output from the GNN model 520. For example, the costing and selection module 250 may calculate a cost of each of the schedules represented by the output set. The costing and selection module 250 then selects the schedule having the optimal cost, e.g., the lowest cost. The costing and selection module 250 provides the selected schedule to the hardware lowering module 260. In other embodiments, the scheduler 240 outputs a single schedule, which may be provided directly to the hardware lowering module 260.

The hardware lowering module 260 configures the neural network according to the selected schedule and provides one or more executable files for execution on the target hardware. For example, a library may include machine code for particular sub-processes, and the hardware lowering module identifies the machine code and configures it according to the selected schedule. The output of the hardware lowering module 260 may be one or more NPU files, which are executable files that run on NPUs. In other examples, the hardware lowering module 260 may generate files intended for execution on different types of hardware, e.g., on CPUs or GPUs, or may generate files that can be executed on multiple different types of hardware.

### Example Learning Environments for the GNN

The GNN model 520 may be trained using any suitable process for training a GNN. In some embodiments, the GNN model 520 is trained using a training data set that includes compilation sets that have been identified as optimal for a particular hardware target, e.g., using the brute force method described above. In other embodiments, the GNN model 520 is trained without any ground truth, e.g., using a reinforcement learning approach.

In the supervised learning approach, a GNN model (e.g., the GNN model 520 for the neural network compiler 220) learns how to generate an optimal schedule based on reference data provided during the training process. This reference data, also referred to as ground truth, is represented by a list of integers that encode the strategy labels. In the training process, the ground truth may be converted into a binary matrix where, for example, the label 1 is associated with the optimal strategy.

For example, for each layer of the neural network, a vector may be formed for each available parameter option, e.g., the first position in the vector represents an integer datatype, the second position in the vector represents a floating point datatype, the third position in the vector represents depthwise tensor segmentation, and the fourth position in the vector represents lengthwise tensor segmentation. If, for that layer, the ground truth indicates that the floating point datatype and depthwise tensor segmentation are the optimal parameters, this may be encoded as the vector [0 1 1 0]. Each layer may have a similar encoding based on the ground truth for that layer, and the encodings are combined into a matrix.

In the reinforcement learning algorithm, a performance estimator can be included in the loop to generate the ground truth. Neural networks can be compiled using different strategy options, and the performance estimator can be used to select the best strategy as a ground truth. Alternatively, observed performance recordings of different compiled neural networks can be used if available. Once the optimal strategy is defined, each layer from the graph network is associated with the strategy. This results in a graph that contains the ground truth, which can be used for training and evaluation. Generation of the ground truth data is described in greater detail with respect to FIG. 7.

FIG. 6 illustrates an example supervised learning environment 600 for a neural network scheduling model, in accordance with various embodiments. The supervised learning environment 600 includes training data 610, which may include the ground truth data described above. The training data 610 may be arranged as a set of input graphs 612, each of which is associated with an optimal schedule 614, e.g., a binary scheduling matrix as described above. The supervised learning environment 600 further includes a loss function 630, which is used in conjunction with the training data 610 to train the GNN model 620. The GNN model 620, after training, may be used as the GNN model 520. The GNN model 620 outputs (e.g., from the head 622) an encoded scheduling strategy based on the input graph, in a similar manner to the GNN model 520, described above. The GNN model 620 includes a head 622, which may be similar to the classification head described with respect to the decoder 530. For a given input graph 622, the head 622 of the GNN model 620 outputs a schedule 625, which is input to a loss function 630.

The training may be performed in multiple steps, also referred to as epochs. At each training epoch, the training algorithm aims to minimize the loss function 630 that represents the distance between the output schedule 625 predicted by the GNN model 620 with respect to the optimal schedule 614. The loss function 630 backpropagates one or more weight updates 645 through the layers of the GNN model 620 to update the GNN model 620. The training process may continue until a certain convergence criterion is reached. For example, the duration of the training process may be specified by a number of epochs or a target loss value.

FIG. 7 illustrates an example flowchart for generating data for training the neural network in the environment of FIG. 6. As described above, the GNN model 620 is trained based on training data or ground truth data. A block generator 710 receives configuration information 702, e.g., a configuration file describing one or more configuration specifications for a neural network. The configuration information 702 may include, for example, input tensor size and output tensor size. The block generator 710 also receives a block definition 704. The block definition 704 may define one or more neural network blocks, e.g., a definition for a Residual Neural Network (ResNet) block. In some cases, the block definition 704 defines a group of blocks, e.g., a ResNet block grouped with an inverted bottleneck block. The block generator 710 generates block objects based on the configuration information 702 and the block definition 704.

A model creator 720 creates a neural network model based on the received block object. The model creator 720 generates neural network models based on the block objects from the block generator 710. For example, the model creator 720 may combine multiple different ones of the block objects (or block object groups), or multiple instances of the same block object (or block object groups), into a neural network model. The model is then passed through two pathways, which may act on the model in parallel (as illustrated in FIG. 7) or serially. In some embodiments, the model creator 720 may output the model in two different formats: one that is suitable for the compiler 750, and another that is suitable for the layer list creator 730.

In a first path, a layer list creator 730 creates a list of layers for the model, and the graph generator 740 generates a graph similar to FIGS. 3 and 4 based on the layers. In a second path, a compiler 750 compiles the neural network. The compiler 750 may be similar to the neural network compiler 220. The compiler 750 may compile the neural network according to multiple different strategy options. For example, the compiler 750 may receive a compiling strategy file (e.g., a JSON file) that indicates different compiling strategies for the compiler 750 to follow in different compilations of the same neural network. A performance estimator 760 estimates the performance of each of the compiling strategies. In other embodiments, actual performance of the neural network on a particular hardware device may be observed. A selector 770 may select the best compiling strategy from the different strategy options, based on the estimated (or observed) performance. The selector 770 may select the best compiling strategy based on one or more performance or cost factors, e.g., as described with respect to the GNN model 520 of FIG. 5.

The strategy mapper 780 maps the best compiling strategy selected by the selector 770 onto the graph generated by the graph generator 740. As illustrated in FIG. 4, the graph represents different compiling strategies, one of which (e.g., one of the paths shown in FIG. 4A or 4B) represents the best compiling strategy. The strategy mapper 780 outputs a graph with the ground truth (i.e., the representation of the best compiling strategy in the graph) identified. This graph may be used as the training data 610 for the supervised learning approach described with respect to FIG. 6.

As an alternative to supervised learning, a reinforcement learning training algorithm may be used. Reinforcement learning does not require a ground truth. The GNN model is trained using reinforcement learning to produce the optimal schedule by selecting the one that gives the best performance.

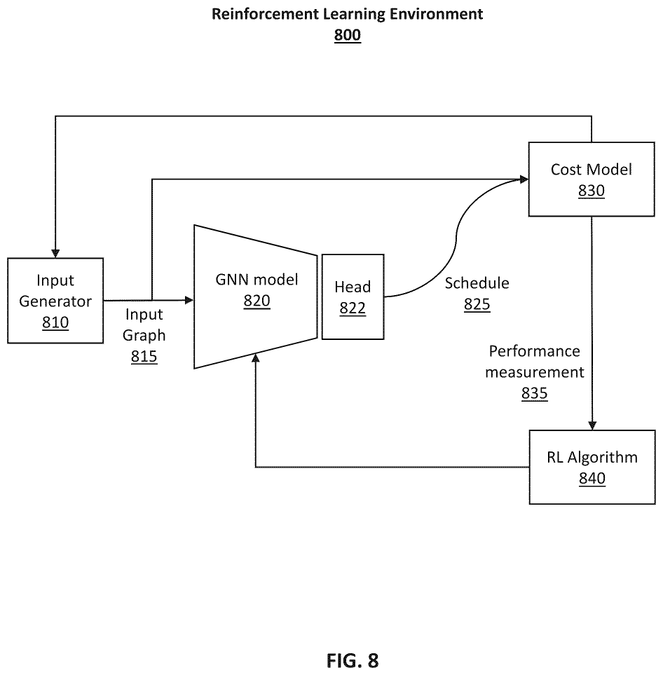

FIG. 8 illustrates an example reinforcement learning environment 800 for a neural network scheduling model, in accordance with various embodiments. A reinforcement learning environment generally has two main components: an agent and a training system. The agent, also referred to as a policy agent, includes the GNN model 820 and the input generator 810. The GNN model 820, after training, may be used as the GNN model 520. The input generator 810 may be a block graph generator that produces graphs of the basic blocks of DNN networks using different configurations, such as input tensor size and output tensor size. Different blocks can be grouped together to provide more variability. For instance, the input generator 810 may group ResNet blocks with inverted bottleneck blocks.

The input generator 810 provides one or more input graphs 815 representing one or more neural networks to the GNN model 820 for training the GNN model 820. The GNN model 820 outputs (e.g., from the head 822) an encoded scheduling strategy based on the input graph, in a similar manner to the GNN model 520, described above. The GNN model 820 includes a head 822, which may be similar to the classification head described with respect to the decoder 530. For a given input graph 815, the head 822 of the GNN model 820 outputs a schedule 825, which is input to a cost model 830.

The training system of the reinforcement learning environment 800 includes the cost model 830 and the RL algorithm 840. The cost model 830 provides a performance measurement 835 that is used as a reward signal. The cost model 830 may be implemented as a software module (e.g., an application programming interface (API)) that consumes a subgraph and a list of strategies, and produces an output describing the cost, e.g., a number of cycles or another performance measurement. The performance measurement 835 output by the cost model 830 may be used directly as the reward measure, or may be used to calculate the reward measure. As one example, the number of cycles may be converted to frames per second (FPS), which can be used as a reward measure. As another example, multiple performance measurements may be mathematically combined to produce an overall cost measurement.

The RL algorithm 840 may use the performance measurement 835 to update the GNN model 820, e.g., to update weights in the GNN model 820. The RL algorithm 840 aims to train the GNN model 820 to directly generate an action, and thus, the RL algorithm 840 may use a policy gradient, such as actor-critic.

A multi-step method may be used to train the GNN model 820. At each step in the method, the GNN model 820 receives a group of DNN blocks from the input generator 810, and the GNN model 820 produces a scheduling strategy. The input graphs 815 in combination with the schedule 825 are used by the cost model 830 to generate a reward, e.g., the performance measurement 835. The RL algorithm 840 may use the performance measurement 835 to update the GNN model 820, e.g., to update weights in the GNN model 820. The performance measurement 835 may also be passed to the input generator 810, which may generate additional graphs based on the performance measurement 835. This process continues until some convergence metric is reached indicating that the GNN model 820 is trained.

### Example Method for Generating a Schedule Using a GNN Model

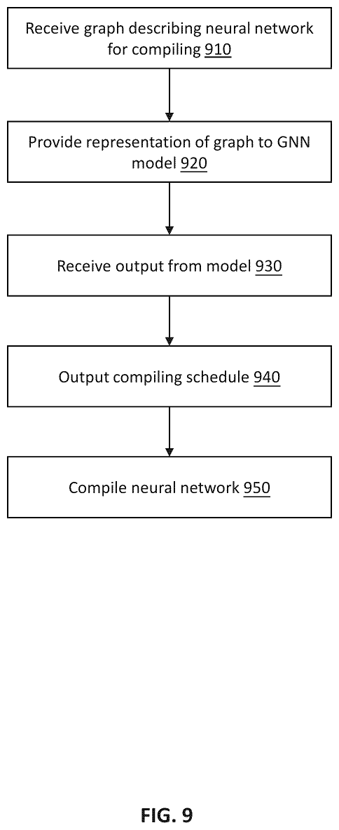

FIG. 9 is a flowchart showing a method of generating a schedule for a neural network compiler, in accordance with various embodiments. At 910, a compiler (e.g., the neural network compiler 220) receives a graph describing a neural network for compiling. In some embodiments, the compiler (e.g., the IR translator 230) generates the graph based on a description of the neural network. The graph may be similar to the graph 300. For example, the graph may include nodes and edges, where the nodes are arranged in multiple layers corresponding to layers in the neural network. One of the nodes in a given layer may represent a parameter or set of parameters of the given layer (e.g., data type, tensor dimension, etc.). The edges may represent dependencies between the layers.

At 920, the compiler (e.g., the neural network compiler 220) provides a representation of the graph to a trained model. For example, the IR translator 230 may output the graph to the scheduler 240. Within the scheduler 240, a feature input module 510 may provide a representation of features of the graph to the GNN model 520. The GNN model 520 may have been trained using supervised or unsupervised learning, e.g., as described with respect to FIGS. 6 and 8.

At 930, the compiler (e.g., the neural network compiler 220) receives an output from the model, e.g., the GNN model 520. For example, the decoder 530 of the scheduler 240 may receive an embedding representing a scheduling configuration of the neural network from the GNN model 520. The scheduling configuration provides a scheduling strategy for each layer of the neural network to be compiled.

At 940, the compiler (e.g., the neural network compiler 220) outputs a compiling schedule for compiling the neural network. For example, the decoder 530 outputs the compiling schedule based on the output embedding received from the GNN model 520.

At 950, the compiler (e.g., the neural network compiler 220) compiles the neural network. For example, the hardware lowering module 260 compiles the neural network according to the schedule provided by the scheduler 240. In some embodiments, if the scheduler 240 outputs multiple possible schedules expected to have low costs, the costing and selection module 250 may compute costs for each of the schedules and select one of the schedules for compiling.

### Example Computing Device

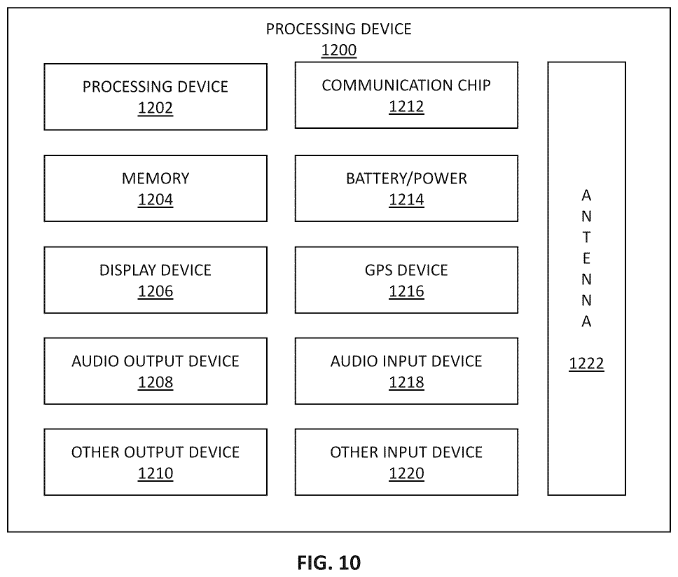

FIG. 10 is a block diagram of an example computing device 1200, in accordance with various embodiments. In some embodiments, the computing device 1200 can be used as the neural network compiler 220 in FIG. 2, or one or more components of the neural network compiler 220, e.g., the scheduler 240. In some embodiments, the computing devices 1200 may be used to implement some or all of a supervised learning environment for training a GNN model, e.g., the supervised learning environment shown in FIG. 6, or some or all of a reinforcement learning environment for training a GNN model, e.g., the reinforcement learning environment shown in FIG. 8. A number of components are illustrated in FIG. 10 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 10, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for compiling, e.g., the method described above in conjunction with FIG. 9 or the operations described above in conjunction with FIGS. 2-8. The instructions stored in the one or more non-transitory computer-readable media may be executed by the processing device 2402.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include an other input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register fileID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

Example 1 provides a method of neural network scheduling, the method including receiving a graph describing a neural network to be compiled, the graph including a plurality of nodes arranged in a plurality of layers with a plurality of edges connecting the plurality of nodes; providing a representation of the graph to a trained graph neural network (GNN) model; receiving an output embedding representing a scheduling configuration of the neural network from the trained GNN model; and outputting a schedule for compiling the neural network based on the output embedding.

Example 2 provides the method of example 1, where the scheduling configuration provides a scheduling strategy for each layer of the neural network to be compiled.

Example 3 provides the method of example 1 or 2, where the output embedding is a first output embedding representing a first scheduling configuration, the method further including receiving a second output embedding representing a second scheduling configuration of the neural network, the second output embedding generated by the trained GNN model; and selecting one of the first scheduling configuration and the second scheduling configuration as the schedule for compiling.

Example 4 provides the method of example 3, where selecting one of the first scheduling configuration and second scheduling configuration includes calculating a first cost value for a first neural network schedule, the first neural network schedule based on the first output embedding; calculating a second cost value for a second neural network schedule, the second neural network schedule based on the second output embedding; and selecting one of the first scheduling configuration and the second scheduling configuration as the scheduling configuration for compiling based on the first cost value and the second cost value.

Example 5 provides the method of any of examples 1-4, where one of the plurality of nodes in a given layer represents at least one parameter of the given layer, and one of the plurality of edges represents a dependency between a first layer and a second layer of the plurality of layers.

Example 6 provides the method of example 5, further including receiving data describing the neural network to be compiled; and generating the graph describing the neural network to be compiled from the data describing the neural network and the parameter, the parameter describing a compiler scheduling option for a particular one of the plurality of layers.

Example 7 provides the method of any of examples 1-6, where at least one layer of the GNN model is trained to encode structural information about the graph describing the neural network to be compiled.

Example 8 provides the method of any of examples 1-7, where the GNN further includes a classification head configured to associate a label to each node of the graph, where the schedule for the neural network to be compiled is represented by the labels.

Example 9 provides the method of any of examples 1-8, where the GNN is trained using a training data set that includes a plurality of training graphs and a corresponding plurality of scheduling strategies, the GNN trained using supervised learning.

Example 10 provides the method of any of examples 1-8, where training the GNN includes generating a schedule for an input training graph using the GNN; calculating a performance measurement for the GNN based on the generated schedule; and updating the GNN based on the performance measurement.

Example 11 provides one or more non-transitory computer-readable media storing instructions executable to perform operations of neural network scheduling, the operations including receiving a graph describing a neural network to be compiled, the graph including a plurality of nodes arranged in a plurality of layers with a plurality of edges connecting the plurality of nodes; providing a representation of the graph to a trained graph neural network (GNN) model; receiving an output embedding representing a scheduling configuration of the neural network from the trained GNN model; and outputting a schedule for compiling the neural network based on the output embedding.

Example 12 provides the one or more non-transitory computer-readable media of example 11, where the scheduling configuration provides a scheduling strategy for each layer of the neural network to be compiled.

Example 13 provides the one or more non-transitory computer-readable media of example 11 or 12, where the output embedding is a first output embedding representing a first scheduling configuration, where the operations further include receiving a second output embedding representing a second scheduling configuration of the neural network, the second output embedding generated by the trained GNN model; and selecting one of the first scheduling configuration and the second scheduling configuration as the schedule for compiling.

Example 14 provides the one or more non-transitory computer-readable media of example 13, where selecting one of the first scheduling configuration and second scheduling configuration includes calculating a first cost value for a first neural network schedule, the first neural network schedule based on the first output embedding; calculating a second cost value for a second neural network schedule, the second neural network schedule based on the second output embedding; and selecting one of the first scheduling configuration and the second scheduling configuration as the scheduling configuration for compiling based on the first cost value and the second cost value.

Example 15 provides the one or more non-transitory computer-readable media of any of examples 11-14, where one of the plurality of nodes in a given layer represents at least one parameter of the given layer, and one of the plurality of edges represents a dependency between a first layer and a second layer of the plurality of layers.

Example 16 provides the one or more non-transitory computer-readable media of example 15, where the operations further include receiving data describing the neural network to be compiled; and generating the graph describing the neural network to be compiled from the data describing the neural network and the parameter, the parameter describing a compiler scheduling option for a particular one of the plurality of layers.

Example 17 provides the one or more non-transitory computer-readable media of any of examples 11-16, where at least one layer of the GNN model is trained to encode structural information about the graph describing the neural network to be compiled.

Example 18 provides the one or more non-transitory computer-readable media of any of examples 11-17, where the GNN further includes a classification head configured to associate a label to each node of the graph, where the schedule for the neural network to be compiled is represented by the labels.

Example 19 provides the one or more non-transitory computer-readable media of any of examples 11-18, where the GNN is trained using a training data set that includes a plurality of training graphs and a corresponding plurality of scheduling strategies, the GNN trained using supervised learning.

Example 20 provides the one or more non-transitory computer-readable media of any of examples 11-18, where training the GNN includes generating a schedule for an input training graph using the GNN; calculating a performance measurement for the GNN based on the generated schedule; and updating the GNN based on the performance measurement.

Example 21 provides an apparatus, including a computer processor for executing computer program instructions; and a non-transitory computer-readable memory storing computer program instructions executable by the computer processor to perform operations including receiving a graph describing a neural network to be compiled, the graph including a plurality of nodes arranged in a plurality of layers with a plurality of edges connecting the plurality of nodes; providing a representation of the graph to a trained graph neural network (GNN) model; receiving an output embedding representing a scheduling configuration of the neural network from the trained GNN model; and outputting a schedule for compiling the neural network based on the output embedding.

Example 22 provides the apparatus of example 21, where the scheduling configuration provides a scheduling strategy for each layer of the neural network to be compiled.

Example 23 provides the apparatus of example 21 or 22, where the output embedding is a first output embedding representing a first scheduling configuration, where the operations further include receiving a second output embedding representing a second scheduling configuration of the neural network, the second output embedding generated by the trained GNN model; and selecting one of the first scheduling configuration and the second scheduling configuration as the schedule for compiling.

Example 24 provides the apparatus of example 23, where selecting one of the first scheduling configuration and second scheduling configuration includes calculating a first cost value for a first neural network schedule, the first neural network schedule based on the first output embedding; calculating a second cost value for a second neural network schedule, the second neural network schedule based on the second output embedding; and selecting one of the first scheduling configuration and the second scheduling configuration as the scheduling configuration for compiling based on the first cost value and the second cost value.

Example 25 provides the apparatus of any of examples 21-24, where one of the plurality of nodes in a given layer represents at least one parameter of the given layer, and one of the plurality of edges represents a dependency between a first layer and a second layer of the plurality of layers.

Example 26 provides the apparatus of example 25, where the operations further include receiving data describing the neural network to be compiled; and generating the graph describing the neural network to be compiled from the data describing the neural network and the parameter, the parameter describing a compiler scheduling option for a particular one of the plurality of layers.

Example 27 provides the apparatus of any of examples 21-26, where at least one layer of the GNN model is trained to encode structural information about the graph describing the neural network to be compiled.

Example 28 provides the apparatus of any of examples 21-27, where the GNN further includes a classification head configured to associate a label to each node of the graph, where the schedule for the neural network to be compiled is represented by the labels.

Example 29 provides the apparatus of any of examples 21-28, where the GNN is trained using a training data set that includes a plurality of training graphs and a corresponding plurality of scheduling strategies, the GNN trained using supervised learning.

Example 30 provides the apparatus of any of examples 21-28, where training the GNN includes generating a schedule for an input training graph using the GNN; calculating a performance measurement for the GNN based on the generated schedule; and updating the GNN based on the performance measurement.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method of neural network scheduling, the method comprising:
receiving a graph describing a neural network to be compiled, the graph comprising a plurality of nodes arranged in a plurality of layers with a plurality of edges connecting the plurality of nodes;
providing a representation of the graph to a trained graph neural network (GNN) model;
receiving an output embedding representing a scheduling configuration of the neural network from the trained GNN model; and
outputting a schedule for compiling the neural network based on the output embedding.

2. The method of claim 1, wherein the scheduling configuration provides a scheduling strategy for each layer of the neural network to be compiled.

3. The method of claim 1, wherein the output embedding is a first output embedding representing a first scheduling configuration, the method further comprising:
receiving a second output embedding representing a second scheduling configuration of the neural network, the second output embedding generated by the trained GNN model; and
selecting one of the first scheduling configuration and the second scheduling configuration as the schedule for compiling.

4. The method of claim 3, wherein selecting one of the first scheduling configuration and second scheduling configuration comprises:
calculating a first cost value for a first neural network schedule, the first neural network schedule based on the first output embedding;
calculating a second cost value for a second neural network schedule, the second neural network schedule based on the second output embedding; and
selecting one of the first scheduling configuration and the second scheduling configuration as the scheduling configuration for compiling based on the first cost value and the second cost value.

5. The method of claim 1, wherein one of the plurality of nodes in a given layer represents at least one parameter of the given layer, and one of the plurality of edges represents a dependency between a first layer and a second layer of the plurality of layers.

6. The method of claim 5, further comprising:
receiving data describing the neural network to be compiled; and
generating the graph describing the neural network to be compiled from the data describing the neural network and the parameter, the parameter describing a compiler scheduling option for a particular one of the plurality of layers.

7. The method of claim 1, wherein at least one layer of the GNN model is trained to encode structural information about the graph describing the neural network to be compiled.

8. The method of claim 1, wherein the GNN further comprises a classification head configured to associate a label to each node of the graph, wherein the schedule for the neural network to be compiled is represented by the labels.

9. The method of claim 1, wherein the GNN is trained using a training data set that comprises a plurality of training graphs and a corresponding plurality of scheduling strategies, the GNN trained using supervised learning.

10. The method of claim 1, wherein training the GNN comprises:
generating a schedule for an input training graph using the GNN;
calculating a performance measurement for the GNN based on the generated schedule; and
updating the GNN based on the performance measurement.

11. One or more non-transitory computer-readable media storing instructions executable to perform operations of neural network scheduling, the operations comprising:
receiving a graph describing a neural network to be compiled, the graph comprising a plurality of nodes arranged in a plurality of layers with a plurality of edges connecting the plurality of nodes;
providing a representation of the graph to a trained graph neural network (GNN) model;
receiving an output embedding representing a scheduling configuration of the neural network from the trained GNN model; and
outputting a schedule for compiling the neural network based on the output embedding.

12. The one or more non-transitory computer-readable media of claim 11, wherein the scheduling configuration provides a scheduling strategy for each layer of the neural network to be compiled.

13. The one or more non-transitory computer-readable media of claim 11, wherein the output embedding is a first output embedding representing a first scheduling configuration, wherein the operations further comprise:
receiving a second output embedding representing a second scheduling configuration of the neural network, the second output embedding generated by the trained GNN model; and
selecting one of the first scheduling configuration and the second scheduling configuration as the schedule for compiling.

14. The one or more non-transitory computer-readable media of claim 13, wherein selecting one of the first scheduling configuration and second scheduling configuration comprises:
calculating a first cost value for a first neural network schedule, the first neural network schedule based on the first output embedding;
calculating a second cost value for a second neural network schedule, the second neural network schedule based on the second output embedding; and
selecting one of the first scheduling configuration and the second scheduling configuration as the scheduling configuration for compiling based on the first cost value and the second cost value.

15. The one or more non-transitory computer-readable media of claim 11, wherein one of the plurality of nodes in a given layer represents at least one parameter of the given layer, and one of the plurality of edges represents a dependency between a first layer and a second layer of the plurality of layers.

16. The one or more non-transitory computer-readable media of claim 11, wherein the operations further comprise:
receiving data describing the neural network to be compiled; and
generating the graph describing the neural network to be compiled from the data describing the neural network and the parameter, the parameter describing a compiler scheduling option for a particular one of the plurality of layers.

17. The one or more non-transitory computer-readable media of claim 11, wherein at least one layer of the GNN model is trained to encode structural information about the graph describing the neural network to be compiled.

18. The one or more non-transitory computer-readable media of any of claims 11-17, wherein the GNN further comprises a classification head configured to associate a label to each node of the graph, wherein the schedule for the neural network to be compiled is represented by the labels.

19. An apparatus, comprising:
a computer processor for executing computer program instructions; and
a non-transitory computer-readable memory storing computer program instructions executable by the computer processor to perform operations comprising:
receiving a graph describing a neural network to be compiled, the graph comprising a plurality of nodes arranged in a plurality of layers with a plurality of edges connecting the plurality of nodes;
providing a representation of the graph to a trained graph neural network (GNN) model;
receiving an output embedding representing a scheduling configuration of the neural network from the trained GNN model; and
outputting a schedule for compiling the neural network based on the output embedding.

20. The apparatus of claim 19, wherein the output embedding is a first output embedding representing a first scheduling configuration, wherein the operations further comprise:
receiving a second output embedding representing a second scheduling configuration of the neural network, the second output embedding generated by the trained GNN model; and
selecting one of the first scheduling configuration and the second scheduling configuration as the schedule for compiling.
